(19) United States
(12) Patent Application Publication
(10) Pub. No.: US 2007/0100798 A1
(43) Pub. Date: May 3, 2007

(54) Community built result sets and methods of using the same

(76) Inventor: Shyam Kapur, Sunnyvale, CA (US)

Correspondence Address: THELEN REID BROWN RAYSMAN & STEINER LLP, 900 THIRD AVENUE, NEW YORK, NY, 10022, US

(21) Appl. No.: 11/264,305

(22) Filed: Oct. 31, 2005

(51) Int. Cl. G06F 17/30

(52) U.S. Cl. 707/3

(57) ABSTRACT

The present invention is directed towards methods and systems that facilitate the searching for and retrieval of one or more result sets, each result set generated by a one or more users. A method according to one embodiment of the present invention comprises receiving one or more query terms from a given user and identifying one or more result set data structures as falling within the scope of the one or more query terms from the given user, a given result set data structure comprising one or more query terms and one or more items in a result set. A community result set is generated on the basis of the one or more result set data structures falling within the scope of the one or more query terms from the given user, which is presented to the given user.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The present invention generally provides methods and systems for searching a corpus of result sets to determine a result set that is responsive to a given query. More specifically, the present invention provides methods and systems that facilitate the searching for and retrieval of one or more result sets, each result set generated by a one or more users. The present invention further provides systems and methods for the generation of result sets by users for searching and retrieval.

Prior to the advent of search engines, users attempting to identify relevant content typically relied on content directories. When initially conceived, content directories were crafted by editors who developed a taxonomy for a directory and reviewed items of content to determine the proper category within the taxonomy in which a given item of content belongs. Over time, closed directory structure that editors create and manage gave way to open directory schemes such as the Open Directory Project (“ODP”) that allows any individual to act as an editor, creating categories in the directory's taxonomy and adding items of content to the categories, e.g., links to items of content such as a URL identifying a web site.

As the number of items of content available on the Internet increases, the use of directories has become increasingly problematic. One of the issues with the use of directories is the ability of the directory to comprehensively catalog the large corpus of content items available on the Internet. It is impractical to use a directory in this manner. Although directories are extremely useful in certain circumstances, the use of directories has been overtaken by the use of search engines. A search engine uses automated techniques to collect or otherwise identify items of content for recordation in an index, the search engine uses the index according to one or more search algorithms to retrieve items of content that are responsive to one or more query terms that a user submits to the search engine. Using a search engine, however, has also has drawbacks. For example, users are not privy to the specific algorithms that the search engine uses to retrieve items of content. Accordingly, users may lack a degree of trust with regard to a set of content items that a search engine retrieves in response to a search request from a given user.

In order to overcome shortcomings and problems associated with existing apparatuses and techniques for searching for and retrieving content items, embodiments of the present invention provide systems and methods for searching result sets build by users that a search engine may present in response to receipt of a search request. The present invention also provides systems and methods for allowing users to create result sets for one or more query terms.

### SUMMARY OF THE INVENTION

The present invention provides systems and method for searching and retrieval of one or more result sets, each result set generated by one or more users. One embodiment of a method according to the present invention for retrieval of a result set in response to a query comprises receiving one or more query terms from a given user and identifying one or more result set data structures as falling within the scope of the one or more query terms from the given user. A given result set data structure may comprise one or more query terms and one or more items in a result set. A community result set is generated on the basis of the one or more result set data structures falling within the scope of the one or more query terms from the given user, which are presented to the given user. The result set may be presented to the user on a client device, which may be a personal computer, set top box, mobile device or other electronic device capable of communicating with other devices over a network.

Generating a community result set according to one embodiment of the present invention comprises aggregating items from the one or more result sets. Aggregating may comprise aggregating items from one or more result sets created by users within the given user's social network. Similarly, aggregating may comprise determining a degree of relatedness between the given user an a user in the given user's social network and aggregating items from one or more result sets created by users within a threshold degree of relatedness to the given user. Alternatively, or in conjunction with the foregoing, aggregation may comprise determining a feature vector for the given user and other users in the given user's social network and comparing the feature vector for the given with the other users in the given user's social network. Items are aggregated from one or more result sets created by users in the given user's social network that comprise similar feature vectors to the feature vector for the given user.

In addition to presenting community result sets, one embodiment of the present method comprises conducting a web based search, generating a web based result set and presenting the web based result set to the given user. The web based result set may be presented to the given user in conjunction with the community result set or instead of the community result set, e.g., when no relevant result set data structures exist.

The present invention also comprises a system for retrieval of a result set in response to a query. According to one embodiment, the system comprises a result set builder component operative to allow for the generation of one or more result set data structures. A given result set data structure may comprise one or more query terms and one or more items in a result set. A result set data store is provided that is operative to provide persistent storage for the one or more result set data structures. A search engine is operative to receive one or more search query terms from a given user. The search engine is further operative to retrieve one or more result set data structures on the basis of a similarity between the one or more search query terms and one or more query terms, generate a community result set on the basis of the one or more result sets and transmit the community result set to the given user. Similarity may be determined on the basis of query equivalence, result equivalence or user profile equivalence.

According to one embodiment, the system comprises a profile data store operative to maintain a profile for the given user, which may comprise information regarding other users within the given user's social network. The search engine may generate the community result set through aggregation of the items from one or more result sets created by users within the given user's social network. The search engine may also determine a degree of relatedness between the given user and a user in the given user's social network, aggregating items from one or more result sets created by users within a threshold degree of relatedness to the given user.

According to another embodiment, the profile for the given user comprises a feature vector for the given user. The search engine may retrieve the feature vector for the given user and other users in the given user's social network, comparing the feature vector for the given user with the other users in the given user's social network and aggregating items from one or more result sets created by users in the given user's social network that comprise similar feature vectors to the feature vector for the given user.

The search engine may also conduct a web based search and generate a web based result set for presentation to the given user. The search engine may present the web based result set in conjunction with, or as an alternative to, the community result set.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram illustrating a system for building and providing result sets according to one embodiment of the present invention;

FIG. 2 is a block diagram illustrating a data structure for storage of result sets according to one embodiment of the present invention;

FIG. 3 is a block diagram illustrating a result set trust network according to one embodiment of the present invention;

FIG. 4 is a flow diagram illustrating a method for building a result set according to one embodiment of the present invention;

FIG. 5 is a flow diagram illustrating a method for retrieving a result set according to one embodiment of the present invention; and

FIG. 6 is a flow diagram illustrating a method for building a result set using a social network according to one embodiment of the present invention.

### DETAILED DESCRIPTION OF THE PREFERRED EMBODIMENT

In the following description of the preferred embodiment, reference is made to the accompanying drawings that form a part hereof, and in which is shown by way of illustration a specific embodiment in which the invention may be practiced. It is to be understood that other embodiments may be utilized and structural changes may be made without departing from the scope of the present invention.

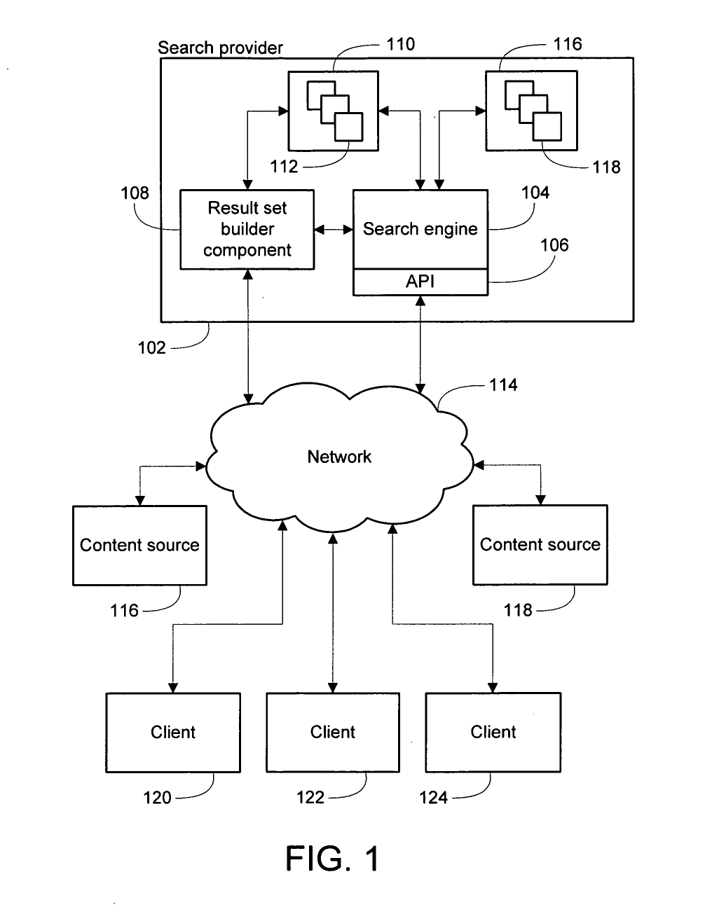

FIG. 1 presents a block diagram illustrating one embodiment of a system for building and providing result sets, which may be provided to users in response to a search query. According to the embodiment of FIG. 1, a search provider 102 comprises one or more software and hardware components to facilitate building and providing result sets including, but not limited to, a search engine 104, an application program interface 106 and a result set builder component 108. The search provider 102 also comprises one or more data stores for providing persistent storage of information used in searching and providing result sets including, but not limited to, a result set data store 110 for storage of one or more result sets 112 and a profile data store 116 for the store of one or more profiles 118.

The search provider 102 is communicative coupled with a network 114, which may include a connection to one or more local and/or wide area networks, such as the Internet. Using the network 114, the search provider 102 is capable of accessing sources of content, 116 and 118, as well as information regarding the same. The search provider 102 may communicate with content sources 116 and 118 for maintaining cached copies of the content and information. The collection of content or references regarding the same is referred to as “crawling”, and is one process by which the search provider 102 collects information upon which the search engine 104 performs searches. Exemplary methods for crawling information on a network are described in commonly owned U.S. Pat. No. 6,021,409, entitled “METHOD FOR PARSING, INDEXING AND SEARCHING WORLD-WIDE-WEB PAGES,” the disclosure of which is hereby incorporated by reference in its entirety.

Collected content may be indexed to allow for efficient retrieval of content that is responsive to a search. According to one embodiment of the invention, the index comprises word-location pairs that allow a search engine 104 to locate specific items of content and information regarding the same in response to a query, which may be from a user, software component, automated process, etc. Exemplary methods for indexing information are described in commonly owned U.S. Pat. No. 5,745,889, entitled “METHOD FOR PARSING INFORMATION OF DATABASE RECORDS USING WORD-LOCATION PAIRS AND METAWORD-LOCATION PAIRS,” the disclosure of which is hereby incorporated by reference in its entirety.

As indicated above, the system of the present invention comprises a result set builder component 108 that allows users to build and store result sets 112 in a result set data store 110. When using the result set builder component 108, a user at a client device 120, 122 and 124 the component 108 presents an interface on the client device 120, 122 and 124 that allows for the building of a result set. The result set builder component may store result sets 112 in the result set data store 110 on a per result set basis. For example, a first user creates a result set for the query terms “chocolate cake” and a second user creates a result set for the query terms “Washington apples”. Storage on a per result set basis comprises storing both the result set and associated search terms in the result set data store 110.

Alternatively, or in conjunction with the foregoing, the result set builder component 108 may store result sets on a per user basis. For example, the result set builder component may store result sets and associated query terms in conjunction with information regarding a user who created the result set. Furthermore, the result set builder component 108 may store result sets in the result set data store on both a per user and per result set basis. The result set data store may be a single data store or a distributed data sore (with components located remotely from the search provider) and comprise a comma delimited data store, a tab delimited data store, a relational database, an object oriented database, a hybrid object-relational database or other data stores known to those of skill in the art.

The result set builder component 108 may allow a given client to build a result set both manually and algorithmically, e.g., through the use of a search algorithm. According to one embodiment, the result set builder allows the user to define one or more query terms in conjunction with the selection of one or more links or references to items of content. For example, a user may define a query as comprising the query terms “Porsche” and “911” in conjunction with a link to content at the address “www.porsche.com/usa/models/911”, in addition to identifying links to content at other addresses. The items in the result set, as well as the query terms that the user defines for the result set, are stored as a result set data structure 110 in the result set data store 112. The result set builder component 108 may also maintain indicia identifying the user who is the author of a given result set data structure 110 in the result set data store 112.

As an alternative, or in conjunction with the foregoing, a user may utilize algorithmic tools to identify items for inclusion in a result set. Accordingly, the search engine 104 exposes an interface 106 through which the result set builder component 108 may use the search engine 104 to execute searches for content that the search engine 104 identifies in its index. It should be understood by those of skill in the art that the result set builder component 108 may also utilize search engines other than the search engine at the search provider 102.

The search engine 104 returns a result set to the result set builder component that the search engine 104 generates according to one or more search algorithms on the basis of query terms that the user supplies. The result set builder component 108 allows the user to select links or references to items of content in the result set that the search engine 104 returns. The result set builder component maintains an indication of the addresses identified by the links that the user selects in conjunction with the query terms that the user supplies. The result set builder component 108 may also maintain indicia identifying the user who is the author of a given result set data structure 110 in the result set data store 112.

The search engine 116 receives search requests from client devices 120, 122 and 124 communicatively coupled to the network 114. A client device 120, 122 and 124 may be any device that allows for the transmission of search requests to a search provider 102, as well as receipt of ranked result sets from the search provider 102. According to one embodiment of the invention, a client device 120, 122 and 124 is a general-purpose personal computer comprising a processor, transient and persistent storage devices, input/output subsystem and bus to provide a communications path between components comprising the general-purpose personal computer. For example, a 3.5 GHz Pentium 4 personal computer with 512 MB of RAM, 40 GB of hard drive storage space and an Ethernet interface to a network. Other client devices are considered to fall within the scope of the present invention including, but not limited to, hand held devices, set top terminals, mobile handsets, etc. The client devices 120, 122 and 124 typically run software applications such as a web browser that provide for transmission of search requests, as well as receipt and display of result sets of content, as well as links to content.

When the search engine 102 receives a search request from a given client 120, 122 and 124, the search engine 102 investigates the result set data store to identify one or more result set data structures that are responsive to the search that the search engine 102 receives. According to one embodiment, the search engine queries the result set data store to select one or more result set data structures that comprise query terms that fall within the scope of the query that the search engine receives. The search engine retrieves one or more responsive result set data structures and transmits the items in the one or more result set data structures to the client from which the search engine receives the query. Alternatively, the search engine may select a subset of the one or more result sets that are responsive to a query for transmission to the client from which the search engine receives the query.

According to embodiments of the invention, the search engine may utilize user profiles to determine items from the one or more result set data structures to transmit to a client from which the search engine receives the query. The search engine may interface with a profile data store to retrieve a profile for a user from which the search engine receives the query. A profile for a given user comprises information regarding the user. Preferably, a profile for a given user comprises information regarding other users in the given user's social network, e.g., other users with which the given user maintains a relationship. Personal information in the profile for a given user may include a feature vector, which according to one embodiment comprises one or more numeric representations of one or more features in a profile for a given user.

The search engine may utilize the profile for the given user to identify users in the given user's social network and query the result set data store to determine if the other users have created result set data structures that are responsive to a query that the search engine receives from the given user. Where one or more responsive result set data structures exist that have been created by other users in the given user's social network, the search engine retrieves the one or more result set data structures. Items in the responsive result set data structures may be presented to the given user. Alternatively, items in responsive result sets from selected other users in the given user's social network are presented to the given user. Selecting other users in the given user's social network comprises selecting other users within a threshold number of degrees from the given user. For example the search engine may present items in response result sets from users in the given user's social network that are within two degrees of the given user, e.g., friends of the given user's friends. According to another embodiment, the search engine provides items in responsive result sets from users in the given user's social network that maintain a relationship strength with the given user that exceeds a threshold. Similarly, the search engine may utilize a feature vector for a given user to identify other users with similar feature vectors. The search engine may provide the given user with responsive result set data structures from other users with similar feature vectors.

The search engine may also query an index (not pictured) to identify content that is responsive to the query that the search engine receives. The search engine executes a search algorithm to generate a result set that comprises links to content falling within the scope of the query. To present the user with the most relevant items in the result set, the search engine 116 ranks the items in the result set. Exemplary systems and methods for ranking search results are described in commonly owned U.S. Pat. No. 5,765,149, entitled “MODIFIED COLLECTION FREQUENCY RANKING METHOD,” the disclosure of which is hereby incorporated by reference in its entirety. According to one embodiment of the invention, the search engine presents the result set generated according to the search algorithm in conjunction with the items of content from result set data structures that are responsive to the query. The selection of result set data structures that are responsive to the query may be made according to whether a user who has created a given result set data structure is within a social network of a given user, the strength of a relationship between the user that created the result set data structure and the given user, a comparison of feature vectors between the user that created the result set data structure and the given user, etc.

The result set data structures comprising query terms and result sets that are built by users of the system may contain information in a result set that is not relevant to the query terms that a user selects for a result set. According to one embodiment, results sets may be presented only from result set data structures created by those users in a given user's social network, thereby allowing the given user to have a high degree of confidence that the result set is accurate on the basis of a trust relationship between the given user and users in the given user's social network. Alternatively, automated content analysis may be utilized to determine the relevance of a result set to query terms in a given result set data structure. Similarly, web based search results may be used to analyze the items in a given result set to determine relevancy. According to another embodiment, community policing and feedback may be utilized to identify a given result set data structure that comprises a result set that is not related to or relevant to the query terms for the given result set data structure. Those of skill in the art recognize that in addition to other techniques know in the art, various combinations of the foregoing techniques may be used.

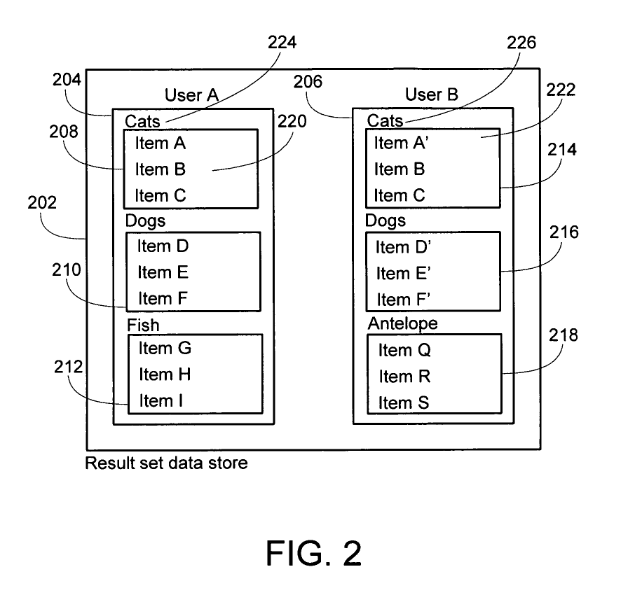

As indicated above, one embodiment of a system according to the present invention comprises a result set data store, one embodiment of which is illustrated by FIG. 2. According to the present embodiment, the result set data store 202 maintains a user data structure 204 and 206 for a user that creates result set data structures. A user data structure 204 and 206 comprises one or more result set data structures 208, 210, 212, 214, 216 and 218. A given result set data structure 208 and 214 comprises one or more query terms 224 and 226, respectively, for a given result set data structure 208 and 214, as well as items that comprise the result set 220 and 222 for a given result set data structure 208 and 214. It should be noted that the result set data store of FIG. 2 stores data on a per user basis, e.g., the result set data store groups result set data structures according to the given user that created a given result set data structure. Those of skill in the art should recognize that these data illustrated in FIG. 2 may easily be stored on a per result set basis by simply storing user information in conjunction with a result set data structure.

The search engine may use the result set data store to locate result set data structures that are responsive to a query that the search engine receives. For example, assume that the search engine receives a query comprising the search term “Cats”. In response, the search engine may query the result set data store and retrieve result set data structures that comprise or are relevant to the query terms “cats” 208 and 214. The search engine retrieves the result set data structures (208 and 214) and presents the items contained therein (220 and 222, respectively) to the client from which the search engine received the query. Alternatively, assume that the search engine identifies that both the user data structures for users A and B, 204 and 206, respectively, comprise a result set data structure 208 and 214, respectively, which is responsive to a query that the search engine receives. The search engine may utilize a profile for the user submitting the query to return items from result set data structures maintained by a user data structure for a user with whom the user submitting the query maintains a relationship, e.g., the user data structure for user A 204.

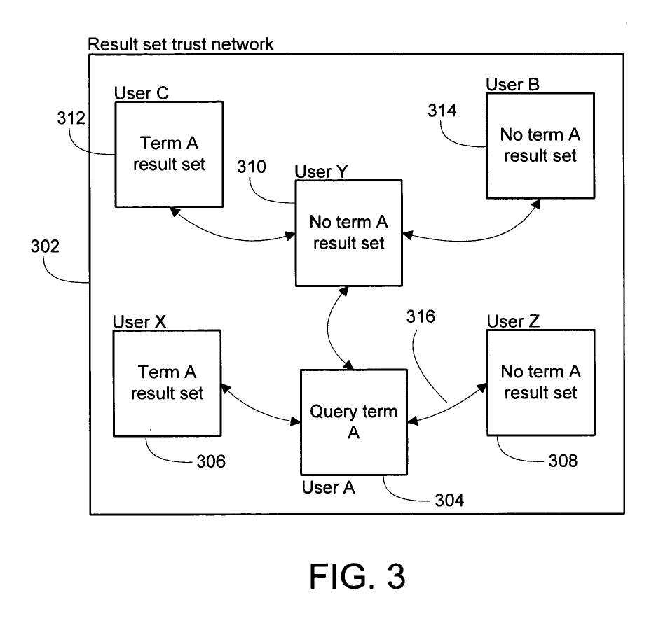

When limiting the return of result set data structures to those from users with whom a given user maintains a relationship, e.g., is within the given user's social network, the search engine may generate a result set trust network, one embodiment of which is illustrated by FIG. 3. The search engine may calculate a result set trust network 302 in response to the receipt of a query from a given user and maintain the result set trust network in transient memory. Alternatively, the search engine may pre-compute the result set trust network 302 for a given user, which the search engine stores in persistent memory for retrieval when a query is received from the given user.

According to the embodiment of FIG. 3, the result set trust network identifies a given user 304, as well as other users 306, 308 and 310 that are within the given user's social network. The search engine may identify other users 306,308 and 310 within the given user's social network by retrieving the given user's profile from the profile data store. Similarly, other users in the given user's social network 310 may also maintain additional relationships 312 and 314, which the search engine may represent in the result set trust network 302 by reference to a profile for a user 310 in the given user's social network. The result set trust network also identifies the relationships 316 between the given user 304 and the other users 306, 308 and 310. According to one embodiment, a given relationship 316 comprises a weight value, which may be calculated according to a similarity between a feature vector for the given user and other users 306, 308 and 310.

In addition to providing a representation between the given user and other users in the given user's relationship network, the result set trust network identifies those users in the given user's social network that have created a result set data structure that falls within the scope of a query that the given user submits to the search engine. According to exemplary result set trust network 302, the user submits a search for query term “A”. The representation of the result set trust network allows the search engine to determine that there is one individual who has created a result set data structure for query term “A” with a direct relationship to the given user. Similarly, the representation of the result set trust network allows the search engine to determine that there is one individual who has created a result set data structure for query term “A” with a second degree relationship to the given user, e.g., a friend of a friend. In response to the receipt of a search for query term “A”, the search engine may use the result set trust network to present the given user with items from the result set data structure from user X, items from the result set data structure from user C, combinations of items from the result set data structure both users X and C. The search engine may supplement any result set that it presents to the user with additional items retrieved from an algorithmic search, for which the search engine may present an indication of the items retrieved from result set data structures and the items retrieved though the user of algorithmic search.

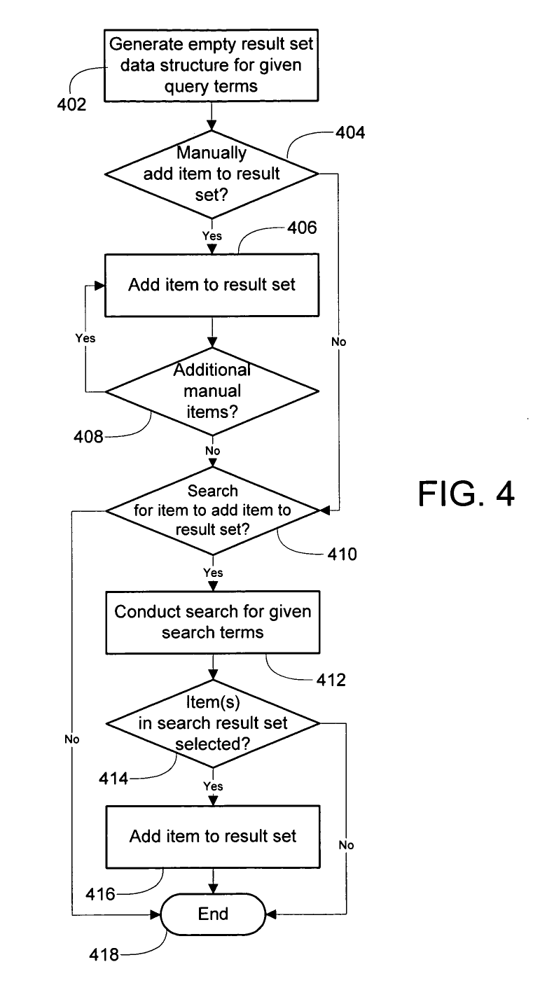

As indicated above, the system of the present invention may be utilized by a user to define one or more query terms in conjunction with one or more items for a result set in a result set data structure. FIG. 4 presents a method for generating a result set data store according to one embodiment of the present invention. The method of FIG. 4 begins with the generation of an empty result set data structure for one or more query terms that the user provides, step 402. The system performs a check to determine if the user wishes to manually add an item to the result set for storage in the result set data store, step 404. According to one embodiment, the system presents a dialog box with a control through which the user may supply an address for an item of content, e.g., a URL to a web page. Those of skill in the art recognize other techniques are known for identifying items of content for inclusion in a result set, which are contemplated as falling within the scope of the present invention.

Where the user wishes to manually add an item to the result set, step 404, the user manually adds an item by supplying an address or other identifying information regarding the item such that the search engine may locate the identified item, step 406. The system performs another check to determine if the user wishes to manually add any additional items to the result set, step 408. Where the check at step 408 evaluates to true, processing returns to step 406 where the user manually adds an item by supplying an address or other identifying information regarding the item such that the search engine may locate the identified item. Accordingly, the user may manually identify items in a result set data store for the system to present when a user submits a query for the query terms associated with the result set data structure. The system also performs a check to determine if the user wishes to search for items to add to the result set data structure, step 410. Where no search is to be conducted for items to add to the result set data structure, step 410, the process ends 418.

Where the check performed at step 410 evaluates to true, the system provides the user with an opportunity to conduct a search for items to add to the result set data structure from a search result set, step 412. According to one embodiment, the user may access a plurality of search engines through which to conduct searches for items to add to the result set data structure from a plurality of search result sets. The system performs a check to determine if the user selects an item from the one or more search result sets, step 414. Where the user selects one or more items, step 414, the items are added to the result set data structure, step 416. Where the user conducts a search for items to add to the result set data structure from a search result set, step 410, but fails to select an item from the search result set for inclusion in the result set data store, step 414, processing ends with storage of the result set data structure, step 418. Storage of the result set data structure may comprise storing the result set data structure on a per user or per result set basis.

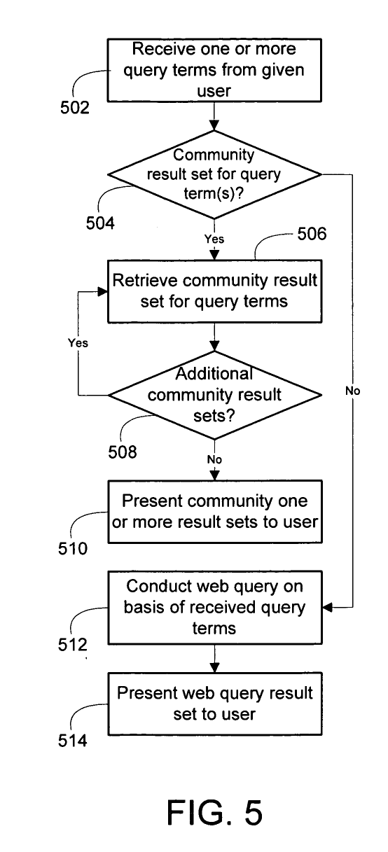

Users create one or more result set data structures and the system may serve items in a result set data structure's result set in response to receipt of a query. FIG. 5 illustrates a method according to one embodiment of the present invention for serving items in one or more result set data structures' result sets. According to the embodiment of FIG. 5, the system receives one or more query terms from a given user, step 502. A check is performed to determine if any result set data structures (also referred to herein as community result sets) exist that fall within the scope of the given user's query, step 504. For example, the system searches a result set data store to determine if a result set data structure exists with the query terms that match or are similar to terms in the given user's query, which may be conduced on the basis of query equivalence, result set equivalence and/or user profile equivalence. The determination of similar queries may also utilize a units data store populated with information regarding the search term frequency and query frequency for an observed universe of search queries. Embodiments of the units data store are described in U.S. patent application Ser. No. 10/713,576, entitled “SYSTEMS AND METHODS FOR GENERATING CONCEPT UNITS FROM SEARCH QUERIES”, filed on Nov. 12, 2003 and assigned attorney docket number 7346/55, the disclosure of which is hereby incorporated by reference in its entirety. Result set data structures according to the present embodiment may be referred to as community result sets because they are result sets created by and available to the community of users utilizing the system of the present invention.

Where a result set data structures exists that falls within the scope of the given user's query, step 504, the system retrieves the responsive result set data structure, step 506. A check is performed to determine if an additional responsive result set data structure exists, step 508. The system continues to check and retrieve any additional responsive result set data structures, steps 506 and 508, until the check performed at step 508 evaluates to false. The items in the one or more result sets comprising the one or more result set data structures are transmitted to the user submitting the query to the system for display on a client device, step 510.

If a result set data structure falling within the scope of the given user's query does not exist, step 504, the system may perform an algorithmic search to locate items of content that are responsive to the given user's query. Accordingly, the system conducts a web-based search on the basis of one or more search terms that the given user provides, step 512, e.g., to a search engine, which may comprise submitting the query terms for execution by a plurality of search engines. The use of multiple search engines may further comprise the use of multiple disparate search algorithms. The result set, which may comprise links to items of content that fall within the scope of the given user's query, is transmitted to the client device being utilized by the given user for display on a display device, step 514.

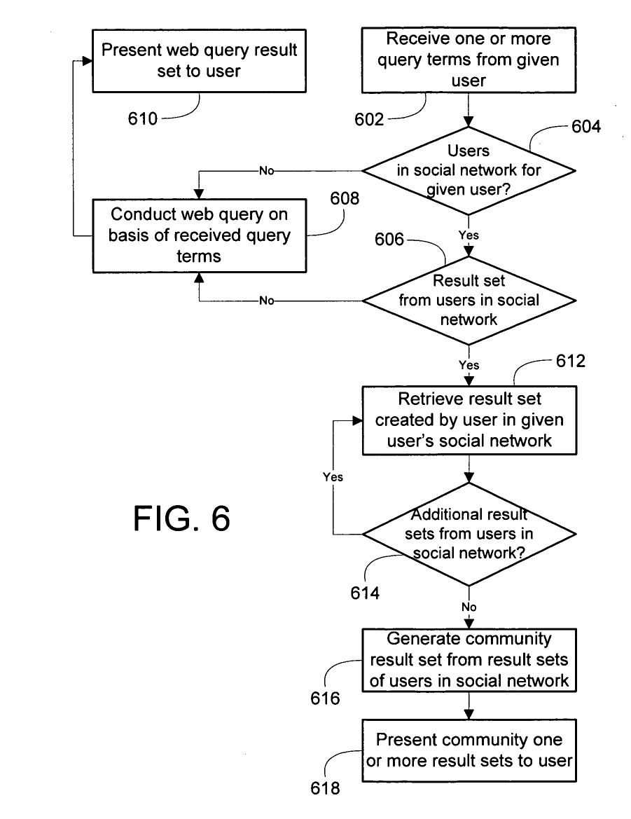

FIG. 6 presents a flow diagram illustrating an alternative embodiment of a method for serving items in one or more result set data structures' result sets. According to the embodiment of FIG. 6, the system receives one or more query terms from a given user, step 602. A check is performed to determine if the given user has one or more users in his or her social network, step 604. Where one or more users exist in the given user's social network, step 604, the system performs a check to determine if the one or more users in the given user's social network have created a result set data structure comprising query terms that fall within the scope of the query that the given user is submitting, step 606. If either of the checks performed at steps 604 and 606 evaluate to false, e.g., there are no users in the given user's social network or those users in the given user's social network have no result set data structures that are responsive to the given user's query, the system may conduct a web-based search on the basis of the query terms that the given user supplies. The result set generated by the web search is transmitted to the client device being utilized by the given user for display on a display device, step 610.

Where the one or more users in the given user's social network have created a result set data structure comprising query terms that fall within the scope of the query that the given user is submitting, step 606, the system retrieves the result set from a user in the given user's social network, step 612. An additional check is evaluated to determine if additional responsive result sets exists from other users in the given user's social network, step 614. The process of steps 612 and 614 repeats until there are no additional responsive result sets available from users in the given user's social network. The one or more retrieved result sets are used to generate a community result set, step 616. According to one embodiment, the community result set comprises the aggregate of the result sets made available from users in the given user's social network. Alternatively, the system may only use those result sets from users within a threshold degree of relatedness to the given user or with whom the given user maintains a relationship that exceeds a given threshold. Relatedness may be determined through the comparison of feature vectors for the given user and users in the given user's social network. The community result set is transmitted to the client device being utilized by the given user for display on a display device, step 618.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

We claim:

1. A method for retrieval of a result set in response to a query, the method comprising:
receiving one or more query terms from a given user;
identifying one or more result set data structures as falling within the scope of the one or more query terms from the given user, a given result set data structure comprising one or more query terms and one or more items in a result set;
generating a community result set on the basis of the one or more result set data structures falling within the scope of the one or more query terms from the given user; and
presenting the community result set to the given user.

2. The method of claim 1 wherein presenting comprises presenting the result set to the user on a client device.

3. The method of claim 1 wherein generating comprises aggregating items from the one or more result sets.

4. The method of claim 3 wherein aggregating comprises aggregating items from one or more result sets created by users within the given user's social network.

5. The method of claim 4 wherein aggregating comprises:
determining a degree of relatedness between the given user an a user in the given user's social network; and
aggregating items from one or more result sets created by users within a threshold degree of relatedness to the given user.

6. The method of claim 4 wherein aggregating comprises:
determining a feature vector for the given user and other users in the given user's social network;
comparing the feature vector for the given with the other users in the given user's social network; and
aggregating items from one or more result sets created by users in the given user's social network that comprise similar feature vectors to the feature vector for the given user.

7. The method of claim 1 comprising:
conducting a web based search;
generating a web based result set; and
presenting the web based result set to the given user.

8. The method of claim 7 comprising presenting the web based result set to the given user in conjunction with the community result set.

9. A system for retrieval of a result set in response to a query, the system comprising:
a result set builder component operative to allow for the generation of one or more result set data structures, a given result set data structure comprising one or more query terms and one or more items in a result set;
a result set data store operative to provide persistent storage for the one or more result set data structures;
and a search engine operative to receive one or more search query terms from a given user, the search engine further operative to retrieve one or more result set data structures on the basis of a similarity between the one or more search query terms and one or more query terms, generate a community result set on the basis of the one or more result sets and transmit the community result set to the given user.

10. The system of claim 9 comprising a profile data store operative to maintain a profile for the given user.

11. The system of claim 10 wherein the profile for the given user comprises information regarding other users within the given user's social network.

12. The system of claim 11 wherein the search engine generates the community result set through aggregation of the items from one or more result sets created by users within the given user's social network.

13. The system of claim 11 wherein the search engine determines a degree of relatedness between the given user and a user in the given user's social network and aggregates items from one or more result sets created by users within a threshold degree of relatedness to the given user.

14. The system of claim 10 wherein the profile for the given user comprises a feature vector for the given user.

15. The system of claim 14 wherein the search engine retrieves the feature vector for the given user and other users in the given user's social network, compares the feature vector for the given user with the other users in the given user's social network and aggregates items from one or more result sets created by users in the given user's social network that comprise similar feature vectors to the feature vector for the given user.

16. The system of claim 9 wherein the search engine conducts a web based search, generates a web based result set and presents the web based result set to the given user. 17. The system of claim 16 wherein the search engine presents the web based result set to the given user in conjunction with the community result set.
